(19) United States
(12) Patent Application Publication
(10) Pub. No.: US 2007/0266624 A1
(43) Pub. Date: Nov. 22, 2007

(54) Promotion device and promotion method for carbon-dioxide assimilation of plant

(75) Inventor: Hiroji Tanaka, Kashiba-shi (JP)

Correspondence Address: KRATZ, QUINTOS & HANSON, LLP, 1420 K Street, N.W., Suite 400, WASHINGTON, DC, 20005, US

(73) Assignee: MHC INC., Osaka-shi (JP)

(21) Appl. No.: 11/435,755

(22) Filed: May 18, 2006

(51) Int. Cl. A01G 7/04

(52) U.S. Cl. 47/1.3

(57) ABSTRACT

A promotion device for carbon-dioxide assimilation of plant provided with a high-voltage generating portion which boosts voltage of electric current from an A/C power source portion and converts the electric current into direct current, and an electrode portion which impresses only minus potential of the current from the high-voltage generating portion. Potential difference between the minus potential impressed to the electrode portion and an earth is −2000 to −6000V. And, the electrode portion is inserted to soil around a root portion of the plant.

### BACKGROUND OF THE INVENTION

1. Field of the Invention

This invention relates to a promotion device and a promotion method for carbon-dioxide assimilation of plant.

2. Description of the Related Art

Generally, in urban areas and industrial areas, where amount of plants is smaller than that of suburban areas, foliage plants are disposed inside and outside of offices, houses, buildings of factories to increase green areas. These foliage plants give people recovering effect and relaxation effect through the sense of vision and smell (of fragrance of flower, for example). And, foliage plants have ability to clean air, contaminated with nitrogen oxides, carbon dioxide, and plus ion, by carbon-dioxide assimilation. This ability becomes more preferable when raised by promotion of the carbon-dioxide assimilation through activating the plants.

On the other hand, people managing agriculture outside the urban area are growing plants as agricultural produce such as vegetables and fruits. Agricultural produce is well grown by promotion of the carbon-dioxide assimilation, and various methods for promotion of the carbon-dioxide assimilation of produce are proposed (refer to Japanese Patent Provisional Publication No. H9-205889 for example).

In No. H9-205889, a growing method of produce, in which water solution of ammonium hydrogen carbonate is disseminated in soil and carbon-dioxide assimilation is promoted by absorption of ammonium hydrogen carbonate through roots of the produce, is disclosed.

However, in the growing method of produce disclosed by No. H9-205889, much labor is required for growing work of produce because the water solution of ammonium hydrogen carbonate as promotion agent of carbon-dioxide assimilation must be disseminated in the soil many times.

And, also in application of the method of No. H9-205889 to growing and activating the foliage plants, much labor is caused for working.

It is therefore an object of the present invention to provide a promotion device and a promotion method for carbon-dioxide assimilation of plant with which plants are easily activated and the carbon-dioxide assimilation is promoted without labor in working for promotion of carbon-dioxide assimilation.

### BRIEF DESCRIPTION OF THE DRAWINGS

The present invention will be described with reference to the accompanying drawings in which:

FIG. 1 is a front view showing an operational state of promotion device for carbon-dioxide assimilation of plant relating to a first embodiment of the present invention;

FIG. 2 is a front view of the promotion device for carbon-dioxide assimilation;

FIG. 3 is a front view of another promotion device for carbon-dioxide assimilation;

FIG. 4 is a diagram of an electric circuit;

FIG. 5 is a front view showing an operational state of promotion device for carbon-dioxide assimilation of plant relating to a second embodiment of the present invention; and

FIG. 6 is a front view showing an operational state of promotion device for carbon-dioxide assimilation of plant relating to a third embodiment of the present invention.

### PREFERRED EMBODIMENTS OF THE INVENTION

Preferred embodiments of the present invention will now be described with reference to the accompanying drawings.

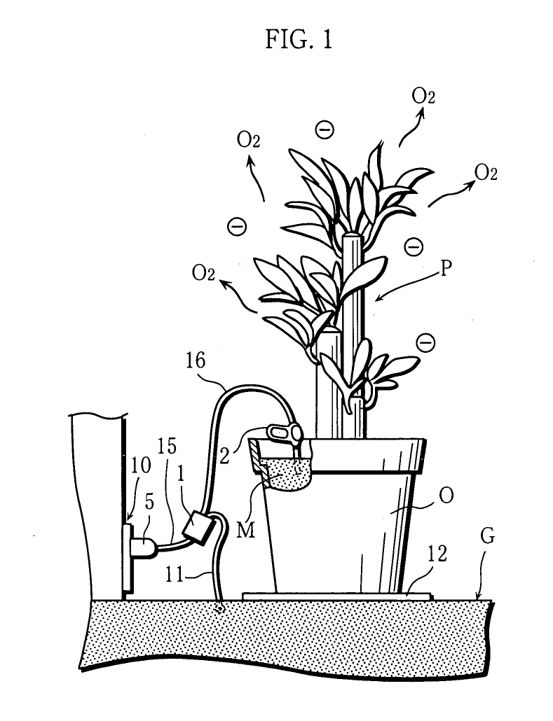

FIGS. 1, 2, and 4 show a first embodiment of the present invention. A promotion device for carbon-dioxide assimilation of plant relating to the first embodiment of the present invention is shown as to be applied to a plant P to be disposed as a foliage plant inside or outside of offices, houses, and buildings of factories.

The promotion device for carbon-dioxide assimilation of plant relating to the first embodiment is provided with a power source connector 5, a high-voltage generating portion 1, an electrode portion 2, and wirings (cords) 15 and 16. The power source connector 5 is, for example, connected to a home-use A/C power source portion (plug socket) 10 of 100V.

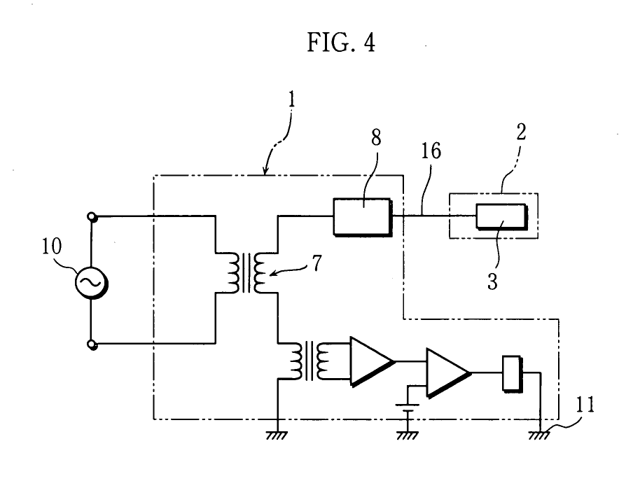

The high-voltage generating portion 1 has a box-like casing and a function which boosts and converts the electricity from the home-use A/C power source portion (plug socket) 10 into direct current. The high-voltage generating portion 1 has a high-voltage transformer 7 and a rectifying portion 8 as shown in FIG. 4. And, the electricity of alternating current from the power source portion 10 is boosted by the high-voltage transformer 7, and converted into direct current by the rectifying portion 8. One of the two wirings on a secondary side of the high-voltage transformer 7 is connected to the rectifying portion 8. And, the other wiring on the other side of the high-voltage transformer 7 is led to an earth 11 through a protection circuit.

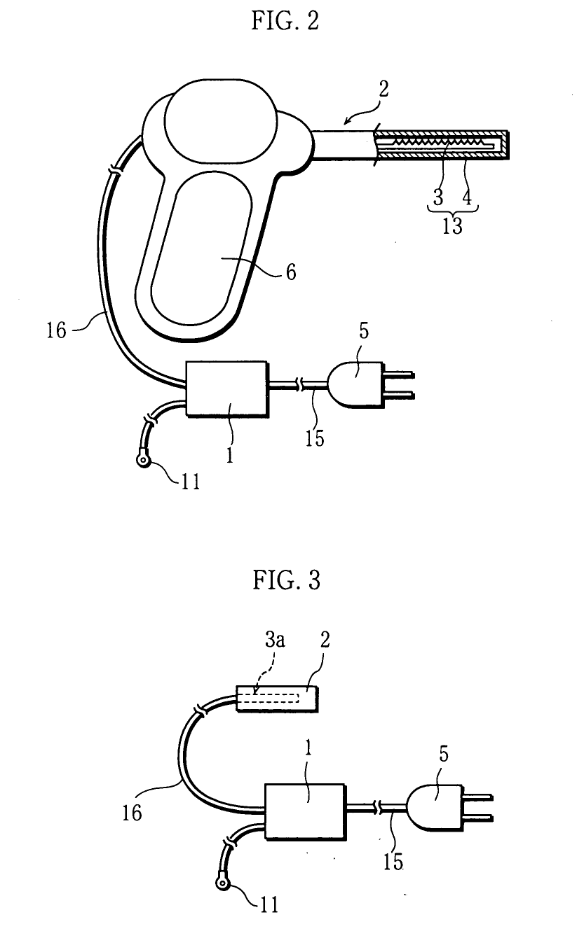

The electrode portion 2 is a portion where only minus potential is impressed by the high-voltage generating portion 1, and set to soil M around the root of a plant P. The electrode portion 2 is connected to the wiring 16 extended from the rectifying portion 8 in the box-like high-voltage generating portion 1 to the outside of the high-voltage generating portion 1. Potential difference between the minus potential impressed to the electrode portion 2 and the earth 11 is set to be −2000 to −6000V. The electrode portion 2 has a configuration having a grip portion 6 and a rod portion 13 protruding from the grip portion 6 as shown in FIG. 2.

The rod portion 13 is a portion inserted to the soil M around the root of the plant P and having a conductor portion 3 and a cover portion 4 formed cylindrical with open end and surrounding the conductor portion 3 as to be insulated from outside. The wiring extended from the high-voltage generating portion 1 is connected to the conductor portion 3 as to accumulate electrostatic potential with impression of the minus potential. This minus potential of the conductor portion 3 works toward outside through the cover portion 4. The conductor portion 3 is composed as to form effective electrostatic field around the electrode portion 2 by, for example, the serrated configuration.

The cover portion 4, composed of insulation material such as plastic, glass, ceramic, may be made of a metal material on an outer side with insulation material on an inner side.

And, the grip portion 6 is gripped when the electrode portion 2 is set to a desired position. With the grip portion 6, the rod portion 13 of the electrode portion 2 can be easily inserted to the soil M around the root of the plant P.

An insulation sheet 12, formed with an insulation material such as plastic, rubber, etc., is disposed between a pot O of the plant P and the ground G. With this insulation sheet 12, the minus potential of the electrode portion 2 can be impressed effectively further to the plant P without receiving external influences.

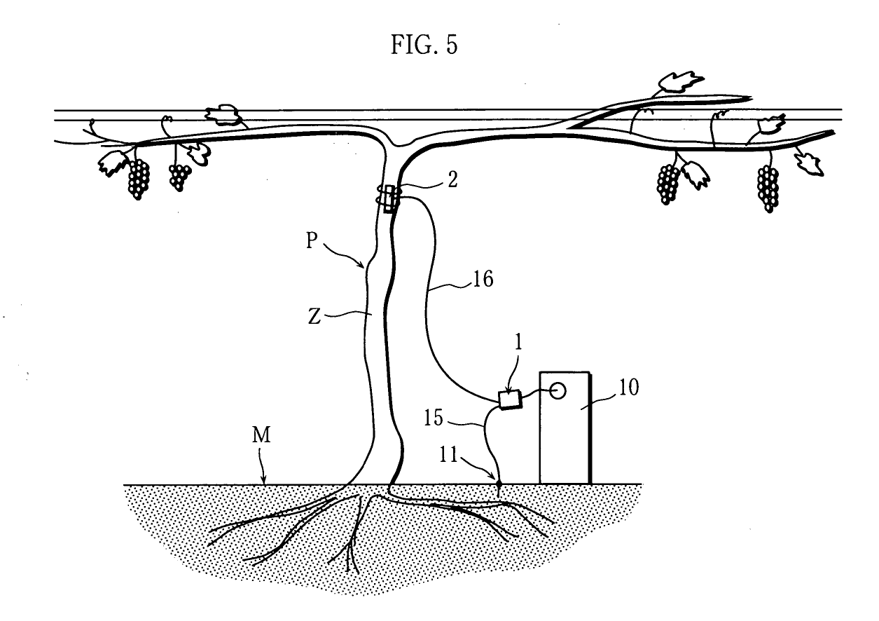

FIG. 5 shows a second embodiment of the present invention. The promotion device for carbon-dioxide assimilation of plant relating to the second embodiment of the present invention is shown as the electrode portion 2 is set to a stem Z of the plant P. When the promotion device for carbon-dioxide assimilation of plant is applied to the plant P, larger than the (above-mentioned) foliage plant, such as a fruit tree, the promotion effect of growing the plant P (fruit) is more enhanced when the electrode portion 2 is set (touching) to the stem Z than when inserted to the soil M around the root of the plant P. As described above, in the promotion device for carbon-dioxide assimilation of plant relating to the the present invention, the setting position of the electrode portion 2 may be changed according to the size, kind, and state of the plant P.

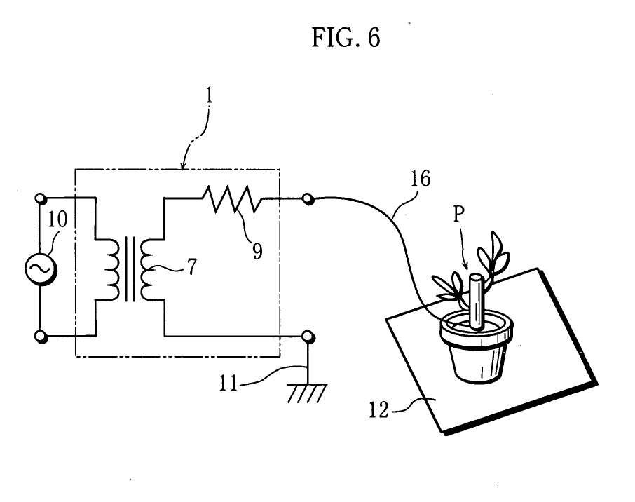

FIG. 6 shows a third embodiment of the present invention. The promotion device for carbon-dioxide assimilation of plant relating to the third embodiment of the present invention is provided with a high-voltage generating portion 1 which boosts the electricity from the A/C power source portion 10 and an electrode portion 2 which impresses the boosted alternating potential from the high-voltage generating portion 1.

The high-voltage generating portion 1, different from the high-voltage generating portion 1 shown in FIG. 4 and having the rectifying portion 8 to convert the alternating current into direct current, has a resister 9 instead of the rectifying portion 8. Depending on the kind of the plant P, the carbon-dioxide assimilation of the plant P may be promoted more by impressing the alternating potential than by impressing the minus potential of direct current. So it is preferable to use the promotion device for carbon-dioxide assimilation of plant as shown in FIG. 6 depending on the condition.

Next, in the first embodiment shown in FIGS. 1, 2, and 4, using Jacaranda as the plant P, a comparative experiment was conducted to compare an example 1, in which the promotion device for carbon-dioxide assimilation of plant is set to the soil M around the root of the plant P, with a case without the device (a comparison example 1) to observe how the density of carbon dioxide (CO₂) changes along the time progress. The result is shown in Table 1.

In the experiment, the plant set with the promotion device for carbon-dioxide assimilation and the plant without the device were respectively covered by a polyethylene bag, and the density of carbon dioxide (CO₂) was measured by a general-purpose gas analysis unit (CO₂ low density VIA510) made by HORIBA LTD.

TABLE 1

| | |
|---|---|
| TIME | CO₂ DENSITY (ppm) |

| (min) | EXAMPLE 1 | COMPARISON EXAMPLE 1 |
|---|---|---|
| 0 | 415 | 407 |
| 10 | 399 | 355 |
| 20 | 297 | 308 |
| 30 | 236 | 278 |
| 40 | 197 | 256 |

As clearly shown in Table 1, reduction of the density of carbon dioxide (CO₂) is remarkably larger in Example 1 with the promotion device for carbon-dioxide assimilation than in Comparison example 1, and it is confirmed that the promotion device for carbon-dioxide assimilation of the present invention promotes the carbon-dioxide assimilation of the plant P.

Next, in the first embodiment, using Camilla as the plant P, a comparative experiment was conducted to compare an example 2, in which the promotion device for carbon-dioxide assimilation of plant is set to the soil M around the root of the plant P, with a case without the device (a comparison example 2) to observe how burning times of a candle differ. The result is shown in Table 2.

In the experiment, using candles having length of 4.8 cm, the plant set with the promotion device for carbon-dioxide assimilation and the plant without the device were respectively placed in a case made of acrylic resin.

TABLE 2

| | | EXTIN- | | CANDLE |
|---|---|---|---|---|
| | | GUISH | BURNING | LENGTH WHEN |
| | START | TIME OF | TIME | EXTINGUISHED |
| | TIME | CANDLE | (min) | (cm) |
| EXAMPLE 2 | 16:10 | 16:42 | 32 | 0.5 |
| COMPARISON | 14:37 | 14:54 | 17 | 2.9 |
| EXAMPLE 2 | | | | |

As clearly shown in Table 2, burning time of the candle is longer in Example 2 with the promotion device for carbon-dioxide assimilation than in Comparison example 2, and it is confirmed that the promotion device for carbon-dioxide assimilation of the present invention promotes the carbon-dioxide assimilation of the plant P and larger amount of oxygen is generated.

Next, in the first embodiment, using Jacaranda, Dracena, and Camilla as the plant P respectively named as example 3, example 4, and example 5, an experiment was conducted to observe how much minus ion is generated when the promotion device for carbon-dioxide assimilation of plant is set to the soil M around the root of the plant P. The result is shown in Table 3.

KST-900 of KOBE ION SHOKAI (of 4-2-33-101, Uozakinishimachi, Kobe-shi, Hyogo, Japan) was used as an experimental apparatus, and the three kinds of plants P were respectively placed in a case made of acrylic resin.

TABLE 3

| TIME | NUMBER OF MINUS ION PER 1 cm³ | | |
|---|---|---|---|
| (min) | EXAMPLE 3 | EXAMPLE 4 | EXAMPLE 5 |
| 3 | 208,200 | 131,500 | 100,000 |
| 5 | 260,000 | 144,500 | 127,300 |
| 50 | 642,800 | 150,000 | 130,000 |

As clearly shown in Table 3, although generation amount of minus ion differs according to the kind of the plant P, great generation amount of minus ion is confirmed.

Next, in the second embodiment in FIG. 5, using grapevine as the plant P, a comparative experiment was conducted to compare an example 6, in which the promotion device for carbon-dioxide assimilation of plant is set by tying to the stem Z of the plant P with a string, with a case without the device (a comparison example 3) to observe whether Brix % in grapes differs or not. The result is shown in Table 4.

TABLE 4

| | |
|---|---|
| TIME | BRIX % |

| (days) | EXAMPLE 6 | COMPARISON EXAMPLE 3 |
|---|---|---|
| 0 | 13 | 13 |
| 6 | 18 | 14.5 |

As clearly shown in Table 4, it is confirmed that the example 6 set with the promotion device for carbon-dioxide assimilation activates the plant P and increases Brix % more than comparison example 3.

Next, in the first embodiment in FIG. 1, using Jacaranda as the plant P, a comparative experiment was conducted to compare an example T, in which the promotion device for carbon-dioxide assimilation of plant is set to the soil M around the root of the plant P and the alternating potential is added, with a case without impressing the potential as a comparison example 4 and case without the plant P itself as a comparison example 5 to observe whether removal ability of ammonia gas differs or not. The result is shown in Table 5.

The experiment was conducted with the following method. First, the whole plant P, set with the promotion device for carbon-dioxide assimilation, was covered by a polyethylene bag (having a volume of 70 L). Next, a sheet of filter paper (of which diameter is 9 cm), on which 0.2 ml of water solution including 28% of ammonia is dropped, was placed in the polyethylene bag and the bag was closed. Then, density of ammonia in the polyethylene bag after a predetermined time was measured with a detector tube “Ammonia No. 3M” made by GASTEC CORPORATION.

TABLE 5

| | AMMONIA DENSITY (ppm) | | |
|---|---|---|---|
| TIME | | COMPARISON | COMPARISON |
| (min) | EXAMPLE 7 | EXAMPLE 4 | EXAMPLE 5 |
| 10 | 380 | 380 | 390 |
| 20 | 180 | 220 | 410 |
| 30 | 100 | 140 | 390 |

As clearly shown in Table 5, it is confirmed that the plant P has removal ability of ammonia gas (refer to comparison examples 4 and 5), and the removal ability of ammonia gas is higher when the potential is impressed to the soil M around the root of the plant P (example 7).

The present invention, not restricted to the embodiments described above, may be modified within the scope of the present invention. For example, it is preferable to make the A/C power source portion 10 built-in type. With this construction, the promotion device for carbon-dioxide assimilation is made excellent in portableness. And, the electrode portion 2, not restricted to the configuration having the grip portion 6 and the rod portion 13 protruding from the grip portion 6, may not have the grip portion 6.

And, the conductor portion 3 may be exposed instead of being surrounded by the cover portion 4.

And, the configuration of the conductor portion 3, not restricted to the serration, may be preferable to be formed with a bundle of very fine conducting wires 3a surrounded by resin as shown in FIG. 3.

As described above, the promotion device for carbon-dioxide assimilation of plant, provided with the high-voltage generating portion 1 boosting voltage of electric current from the A/C power source portion 10 and converts the electric current into direct current and the electrode portion 2 impressing only minus potential from the high-voltage generating portion 1 to the plant P, can make polarization of electrolyte inside and outside of cells of the plant P with the minus potential impressed to the electrode portion 2 to rectify balance of ion of the plant P. Therefore, in comparison with the case that promotion agent of carbon-dioxide assimilation must be disseminated in the soil M many times, the plant P is easily activated to promote the carbon-dioxide assimilation without causing much labor for the carbon-dioxide assimilation. Consequently, growth of the plant P such as foliage plant, produce, etc. can be promoted. And, oxygen and minus ion generation of the plant P is enhanced by the promotion of the carbon-dioxide assimilation and transpiration of the plant P. Therefore, cleaning ability of contaminated air around the plant P is improved. Further, the device contributes to prevention of the global warming.

The same promotion device for carbon-dioxide assimilation of plant can be applied to different kinds of foliage plants and agricultural produce as the plant P because the promotion device activates the plant P and promotes carbon-dioxide assimilation and transpiration.

The electricity is easily supplied to the promotion device for carbon-dioxide assimilation of plant with the (home-use) A/C power source portion 10.

The plant P can be given the minus potential of appropriate value by setting the potential difference between the minus potential impressed to the electrode portion 2 and the earth 11 to be −2000 to −6000V to make the plant P conduct the carbon-dioxide assimilation efficiently. Consequently, the plant P such as foliage plants, agricultural produce, etc. is efficiently grown.

And, the promotion device for carbon-dioxide assimilation of plant, provided with the high-voltage generating portion 1 boosting voltage of electric current from the A/C power source portion 10 and the electrode portion 2 impressing electric potential (of alternating current) from the high-voltage generating portion 1 to the plant P, can make polarization of electrolyte inside and outside of cells of the plant P with the potential of alternating current impressed to the electrode portion 2 to rectify balance of ion of the plant P. Therefore, in comparison with the case that promotion agent of carbon-dioxide assimilation must be disseminated in the soil M many times, the plant P is easily activated to promote the carbon-dioxide assimilation without causing much labor for the carbon-dioxide assimilation. Consequently, growth of the plant P such as foliage plant, produce, etc. can be promoted. And, oxygen and minus ion generation of the plant P is enhanced by the promotion of the carbon-dioxide assimilation and transpiration of the plant P. Therefore, cleaning ability of contaminated air around the plant P is improved.

The same promotion device for carbon-dioxide assimilation of plant can be applied to different kinds of foliage plants and agricultural produce as the plant P because the promotion device activates the plant P and promotes carbon-dioxide assimilation and transpiration.

The electricity is easily supplied to the promotion device for carbon-dioxide assimilation of plant with the (home-use) A/C power source portion 10.

In comparison with the method that promotion agent of carbon-dioxide assimilation must be disseminated in the soil M many times, the work for promotion of the carbon-dioxide assimilation is made easy for the construction in which the electrode portion 2 is inserted to the soil M around the root of the plant P.

The carbon-dioxide assimilation is easily promoted even if the plant P is large by setting the electrode portion 2 to the stem Z of the plant P.

User's hand is prevented from touching the electrode portion 2 and being electrified by the electrode portion 2 having the conductor portion 3 electrically connected to the high-voltage generating portion 1 and the cover portion 4 surrounding the conductor portion 3 as to be insulated from outside. The safety of the device is enhanced thereby.

And, the promotion method for carbon-dioxide assimilation of plant, in which the minus electric potential of −2000 to −6000V is impressed to the soil M around the root of the plant P or the stem Z of the plant P, can make polarization of electrolyte inside and outside of cells of the plant P with the potential of alternating current added to the electrode portion 2 to rectify balance of ion of the plant P. Therefore, in comparison with the case that promotion agent of carbon-dioxide assimilation must be disseminated in the soil M many times, the plant P is easily activated to promote the carbon-dioxide assimilation without causing much labor for the carbon-dioxide assimilation. Consequently, growth of the plant P such as foliage plant, produce, etc. can be promoted.

While preferred embodiments of the present invention have been described in this specification, it is to be understood that the invention is illustrative and not restrictive, because various changes are possible within the spirit and indispensable features.

1. A promotion device for carbon-dioxide assimilation of plant comprising a high voltage generating portion boosting voltage of electric current from an A/C power source portion and converts the electric current into direct current, and an electrode portion impressing only minus potential from the high voltage generating portion to a plant,
wherein the difference between the minus potential impressed to the electrode portion and an earth is −2000 to −6000V.

2. (canceled)

3. A promotion device for carbon-dioxide assimilation of plant comprising a high voltage generating portion boosting voltage of electric current from an A/C power source portion, and an electrode portion impressing electric potential from the high voltage generating portion to a plant.

4. A promotion device for carbon-dioxide assimilation of plant according to claim 1 or 3, wherein the electrode portion is inserted to soil around a root of the plant.

5. A promotion device for carbon-dioxide assimilation of plant according to claim 1 or 3, wherein the electrode portion is set a stem of the plant.

6. A promotion device for carbon-dioxide assimilation of plant according to claim 1 or 3, wherein the electrode portion has a conductor portion electrically connected to the high-voltage generating portion, and a cover portion surrounding the conductor portion as to be insulated from outside.

7. A promotion method for carbon-dioxide assimilation of plant comprising a process in which minus electric potential of −2000 to −6000V is impressed to soil around a root of a plant or a stem of the plant.
